(19) United States
(12) Patent Application Publication
(10) Pub. No.: US 2005/0015332 A1
(43) Pub. Date: Jan. 20, 2005

(54) Cashless payment system

(76) Inventor: Grace Chen, Houston, TX (US)

Correspondence Address: ROBERT C. CURFISS;JACKSON WALKER L.L.P., SUITE 2100, 112 EAST PECAN STREET, SAN ANTONIO, TX, 78205, US

(21) Appl. No.: 10/622,718

(22) Filed: Jul. 18, 2003

(51) Int. Cl. G06F 17/60

(52) U.S. Cl. 705/39; 705/17; 705/42

(57) ABSTRACT

A payment system that does not rely on credit or debit cards, does not require the merchant and purchaser to have compatible memberships to complete a transaction, and does not limit single transactions to a single account provides a wide range of flexibility permitting debit, credit, pre-paid and payroll cards to be accommodated in a seamless and invisible manner to the electronic transaction network. The transaction may be verified and approved at the point-of-sale whether or not the merchant is a member of a specific financial transaction system. Specifically, the point-of-sale transaction system permits an identified customer to use any of a variety of payment options to complete the transaction without requiring the merchant to pre-approve the type of payment selected by the customer. In one configuration, and in order to take advantage of the widespread use of the ATM/POS network, the invention uses a typical credit/debit card format to provide the identifying information in a stored value card. When a transaction is to be completed, the user enters the identifying information carried on the card at the point-of-sale. This can be a merchant or other service provider at a retail establishment, or on-line while the user is logged onto a web site, or other location. The information can be swiped by a card reader, or manually entered via a keyboard or other input device. The system supports a wide range of flexibility, permitting issuing systems such as parents and state welfare agencies to restrict the types of authorized uses, and permitting users to access accounts in a prioritized manner. Further, the accepting merchant is not required to be a member because settlement with the merchant may be made via the Federal Reserve Automatic Clearing House (ACH) system by typical and standard electronic transfer. This permits the merchant to take advantage of the lower ACH transaction fees with even greater convenience and flexibility than the current ATM/POS system. The system supports numerous types of identification methods from typical credit card structures with magnetic data strips to various biometric systems such as finger prints, facial recognition and the like. Specifically, once the user is identified, the transaction is managed by his membership data on record with the transaction processing system.

### BACKGROUND OF THE INVENTION

1. Field of the Invention

The subject invention is related to point-of-sale payment systems and terminals and is specifically directed to a system wherein a purchase or financial transaction may be made outside the ATM/POS debit/credit network using typical point-of-sale terminal systems.

2. Discussion of the Prior Art

Over the last several decades, point-of-sale payment systems have become the normal method of making payment for a transaction. Typically, a credit or debit card containing cardholder information is read at a point of sale terminal which is dedicated to and identifies a specific merchant or other service provider. The merchant or other service provider then enters the transaction amount. The information is transmitted, usually of telephone or other network system, to the ATM/POS/EFT network where it is transmitted to the cardholder's financial institution. The institution then either approves or rejects the transaction based on the funds availability and other preset qualifiers applying to the cardholder at the time of the transaction. If the transaction is accepted, the cardholder's account is immediately debited and typically, the merchant's registered account is credited at a settlement made generally within 1-4 business days. In order for this system to be useful to the merchant and the cardholder, both the merchant and the cardholder have to be registered members of the card issuing network. In addition, the card issued by the financial institution has to be part of the ATM/POS/EFT network.

More recently, similar type of transactions are becoming commonplace over the Internet, wherein the purchaser makes a purchase via a computer terminal. In this case, the cardholder typically enters the information carried on the card manually at the computer terminal while logged onto a merchant or other service provider site. The remainder of the transaction is the same as with card reader point-of-sale terminals, namely, the merchant provides identifying data and transactional data along with the purchaser's card data. The transaction is then transmitted over the ATM/POS/EFT system to the purchaser's card issuing financial institution where the transaction is either accepted or rejected.

Other types of “cashless” transactions have become available because of the widespread connectivity to the ATM/POS network. For example, some state welfare systems offer debit card benefits. Also, some employers are beginning to issue payroll cards instead of checks. Some card issuing financial institutions issue pre-paid cards which are not tied directly to an account which is to be debited, but include the amount directly on the card, to be automatically updated each time a transaction is made.

Typically, debit card transactions require a PIN (Personal Identification Number) to be entered by the customer to complete the transaction. Credit card transactions typically do not require a PIN. This creates a security issue since any person holding the credit card may use it to complete a point-of-sale transaction. The PIN system is not necessarily the answer for security because it requires the user to memorize another number and because PIN supported transactions are not generally accepted over the Internet. Biometrics and other identification systems are now being introduced to further enhance the security of such transactions.

Another drawback to the system is the transaction fees associated with each transaction. In order for a merchant to accept this type of payment, the merchant must be a member of the issuing financial institution network, permitting transaction fees to be deducted from each transaction conducted by the member merchant. For example, the merchants would prefer to complete transactions over the ACH network rather than the ATM/POS network because of the lower fees involved. However, convenience of the card system, which is ATM/POS dependent, makes this the system of choice when compared to the ACH settlement system.

There have been recent upgrades to the ACH settlement system to make it more desirable as a point-of-sale transaction system, but it is still less convenient than the ATM/POS network. For example, some merchants now have the capability of reading the check electronically and inputting the transaction into the system generally referred to as check truncation, or electronic check conversion. This does not actually immediately debit an account but does permit the POS scanner to read the routing and transit numbers and the account number contained on the check with the transaction amount manually entered. The information is converted to an ACH transaction and is generally settled within 2-3 business days. Check verification and check guarantee are risked based offerings provided by the third party vendors of the check reading system. This system still requires some form of paper check manually completed by the purchaser at the point-of-sale.

It is well known that credit cards have been utilized as point-of-sale transaction tools for many decades. In the early years, a paper transaction copy was made and sent to the credit card processor. More recently, electronic point-of-sale terminals have made credit card transactions operate much in the same manner as ATM/POS debit cards. Specifically, the credit card is electronically read and the user identification and transaction information is sent directly to the credit card issuer where it is either authorized or rejected based on user validity and availability of funds. Only the credit card issuer can authorize its use and both the user/customer and the merchant must be members of the same card payment network system. Specifically, one financial institution is involved in the transaction. The single financial payment system accepts the transaction and later settles with the merchant's bank on a prescribed schedule.

Even earlier, and still in use, is the use of checks or drafts as point-of-sale transaction tools. Check readers are now available to authenticate the check but such systems generally do not confirm the availability of funds or electronically reconcile the merchant's account on line at the time of acceptance of the check.

In addition, with all forms of transaction tools mentioned, each transaction is limited to a single financial account of the user, whether as a cardholder or through the use of a check or draft. In some cases, the cardholder may want the transaction to be split among several accounts. By way of example, the cardholder may desire to pay a portion of a purchase with a credit account and a portion with a cash or debit account. The present system can only accommodate this by completing two separate transactions.

In summary, the current payment systems rely heavily on the ATM/POS network, the credit card system or the even older check acceptance system, requiring both the merchant and the purchaser to be members or account holders of compatible financial institutional systems. The system permits only one purchaser account to be accessed during each transaction. The system users incur managed transaction fees for every transaction.

### SUMMARY OF THE INVENTION

The subject invention is directed to a new and novel payment system that does not rely on credit or debit cards, does not require the merchant and purchaser to have compatible memberships to complete a transaction, and does not limit single transactions to a single account. The system has a wide range of flexibility and permits debit, credit, stored-value (payroll card, expense card, gift card and the like) cards and other accounts to be accommodated in a seamless and invisible manner. The transaction may be verified and approved at the point-of-sale whether or not the merchant is a member of a specific financial transaction system.

Specifically, the financial transaction system of the subject invention is a point-of-sale transaction system that permits an identified customer to use any of a variety of payment options to complete the transaction without requiring the merchant to pre-approve the type of payment selected by the customer. In its preferred form, the invention uses a typical credit/debit card format to provide the identifying information in a stored value card using the stored value processing (SVP) system of the subject invention. When a transaction is to be completed, the user enters the identifying information carried on the SVP card at the point-of-sale. This can be a merchant or other service provider at a retail establishment, or on-line while the user is logged onto a web site, or other location. The information can be swiped by a card reader, or manually entered via a keyboard or other input device.

In order to permit widespread acceptance and usability of the system, the SVP information is then transmitted to an ATM/POS gateway in standard fashion, along with the transaction data and the merchant identification. A virtual switch intercepts the transmitted transaction information and redirects it from the ATM/POS system to the system of the subject invention.

The SVP customer/user is a member of the system and will have instructed the system to handle his transactions in a specific manner. For example, the customer member may instruct the system to prioritize use of his accounts, e.g., first debiting a cash account so long as the balance stays above a specific floor, and then charging the transaction to one or more credit accounts. In addition, the system will permit customization not previously supported. For example, if the service provider is a medical clinic and the user has a health plan with a co-pay or deductible, the SVP system will permit the customer to pay for the services and automatically deduct the co-pay or deductible from a customer cash or credit account while making the remaining payment from the insurance carrier account.

In another example, a third party SVP card may be issued by the SVP member, such as, by way of example, a student card. In this application, the holder of the student card will be authorized to make certain transactions within preset time and amount limits, or other criteria. However, the transaction may be directed to the SVP member's selected accounts rather than requiring a pre-paid account to be set up for the student.

The system of the subject invention supports a wide range of flexibility, permitting issuing systems such as parents and state welfare agencies to restrict the types of authorized uses, and permitting users to access accounts in a prioritized manner. Further, the accepting merchant is not required to be a member because settlement with the merchant may be made via the ACH system by typical and standard electronic transfer. This permits the merchant to take advantage of the lower ACH transaction fees with even greater convenience and flexibility than the current ATM/POS system.

The system of the subject invention supports numerous types of identification methods from typical credit card structures with magnetic data strips to various biometric systems such as finger prints, facial recognition and the like. Specifically, once the SVP user is identified, the transaction is managed by his membership data on record with the transaction processing system.

While the preferred embodiment of the invention utilizes an ATM/POS network and diverts the transaction once initiated, the system is fully a standalone financial system. The ATM/POS gateway is used as a convenience because of its widespread acceptance and availability. The system can be configured to direct all transactions directly to a system gateway where desired without any loss of transaction processing flexibility.

### BRIEF DESCRIPTION OF THE DRAWINGS

FIG. 1 is a basic point-of-sale system diagram in accordance with the subject invention.

FIG. 2 is a detailed diagram of the virtual payment switch shown in FIG. 1.

FIG. 3 is a diagram of the settlement process in accordance with the subject invention.

FIG. 4 is a diagram showing routing number and consolidation tracking.

FIG. 5 is a diagram showing typical payment transactions using the system of the subject invention.

FIG. 6 is a diagram showing an overview of the authorization process.

FIG. 7 is a diagram showing the authorization process in detail.

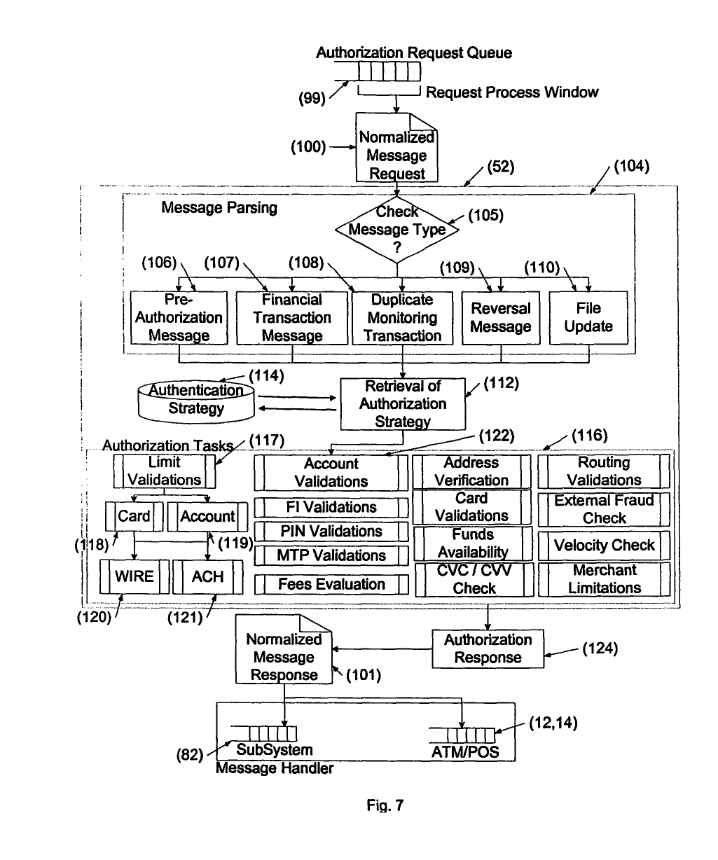

FIG. 8 is a diagram showing an overview of the message handler system and process.

FIG. 9 is a diagram of a typical network architecture in accordance with the subject invention.

FIG. 10 is a flow chart of a direct debit transaction flow.

FIG. 11 is a flow chart of a direct debit settlement.

FIG. 12 is a comprehensive system diagram.

### DETAILED DESCRIPTION

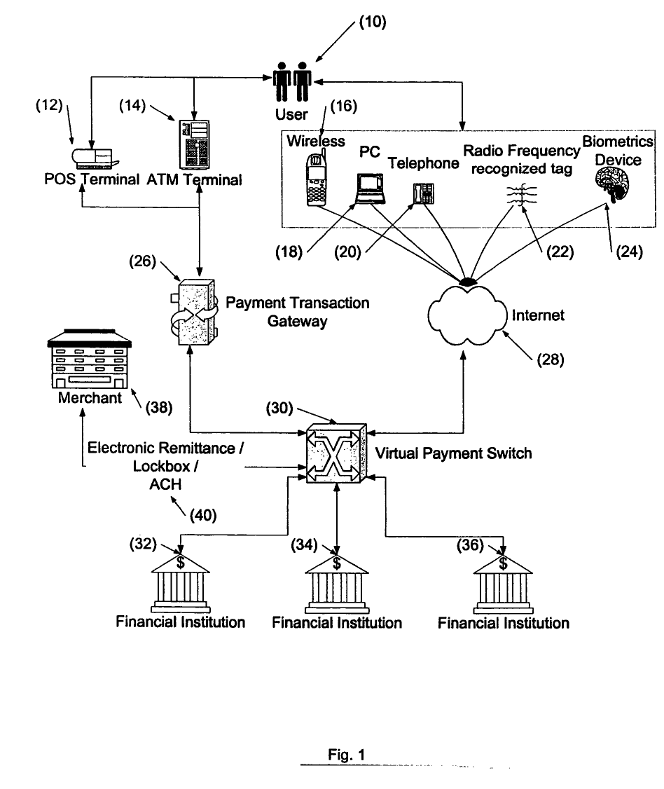

The system of the subject invention permits user/customers to set up an account with a stored value processing (SVP) system for completing financial transactions in a wide variety of applications. SVP system users are assigned valid credentials which permits a user 10 (see FIG. 1) to log onto the system via a variety of input devices such as the point-of-sale (POS) terminal 12, the ATM/POS terminal 14, a cell phone or other wireless device 16, a personal computer 18, telephone 20 or other input device. The system also supports input devices such as radio frequency or infrared tags or similar devices 22 and biometric identification such as finger prints, facial recognition or other system 24.

The input devices permit the user 10 to log on in a variety of ways. For example, a radio frequency tag 22 may be mounted on the windshield of a vehicle for payment of tolls on a toll road. The POS and ATM/POS terminals 12 and 14 may be used for typical credit/debit card type transactions. Biometric identification systems 24 may be useful for many transactions where security is of significant concern.

The purpose of each of the input devices is to provide validating data identifying the user. In the case of the POS terminal and the ATM/POS terminal, the user data is transmitted to a payment transaction gateway 26 where it is diverted from the ATM/POS system to a virtual switch 30. In the case of other input devices, the data will be transmitted via other network systems such as the Internet as indicated by the cloud 28, hard wired telephone lines or the like. Transaction data is transmitted in a similar fashion to the virtual switch 30.

At this point, the virtual switch will contain the user identification, the transaction detail and the merchant identification. The virtual switch 30 then accesses the user's financial institution(s) 32, 34, 36 to determine the availability of funds in the priority established by the user when he set up the account. The system then communicates to the user and the merchant whether the transaction is accepted or declined. If accepted, the system will then settle with the merchant at a prescribed interval by making an electronic transfer from the selected financial institution(s) to the merchant 38 via the ACH network 40.

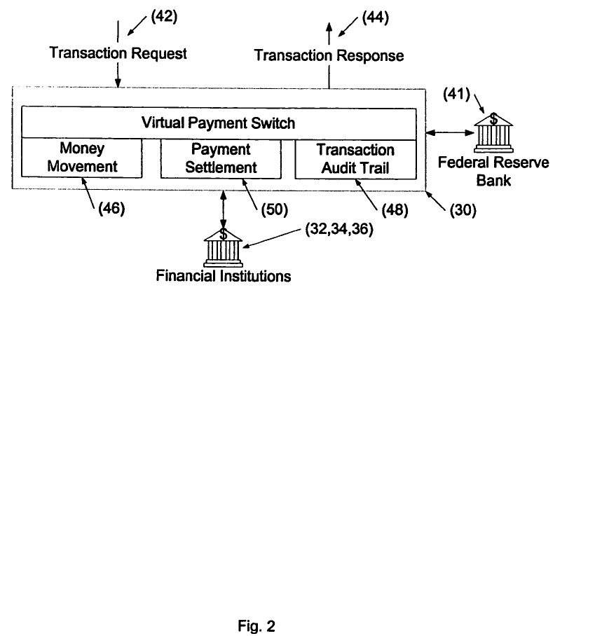

The virtual switch system is shown in more detail in FIG. 2. A transfer request is made by the user at one of the input devices, as indicated at 42. The virtual payment switch receives the request and then communicates with the selected financial institutions or other EFT Network connections as proscribed by the routing rules configured in the virtual switch (such as Painless EFT, Wire Transfer, and the like domestically, or SWIFT or CHIPS internationally) to determine whether the request may be authorized. This decision is then communicated back to the input device and/or merchant as indicated at 44. If authorized, the money is moved from the financial institution(s), i.e., debited as indicated at 46. A transaction audit trail is generated as indicated at 48. This provides the data for a report to be sent to the user and a separate report to be sent to the merchant at prescribed intervals.

Upon settlement, as indicated at 50, the funds are electronically transferred via the virtual switch through the ACH system of the Federal Reserve Bank 41.

This system provides an authorized accounting process on money movement requests with assured proper financial transactional logistics. Web based money movement is supported through authorized processing to direct, validate and fulfill financial transaction requests from any of the wide variety of available input devices. The settlement instruction sets among all participants is based on logic that is defined and verified by the participants, permitting credit, debit and cash transactions as directed. Full audit trails are generated and maintained.

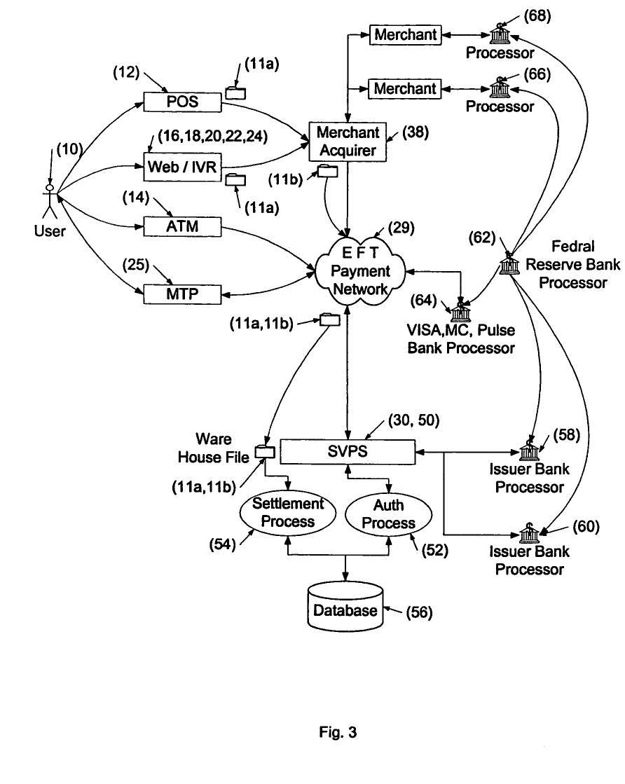

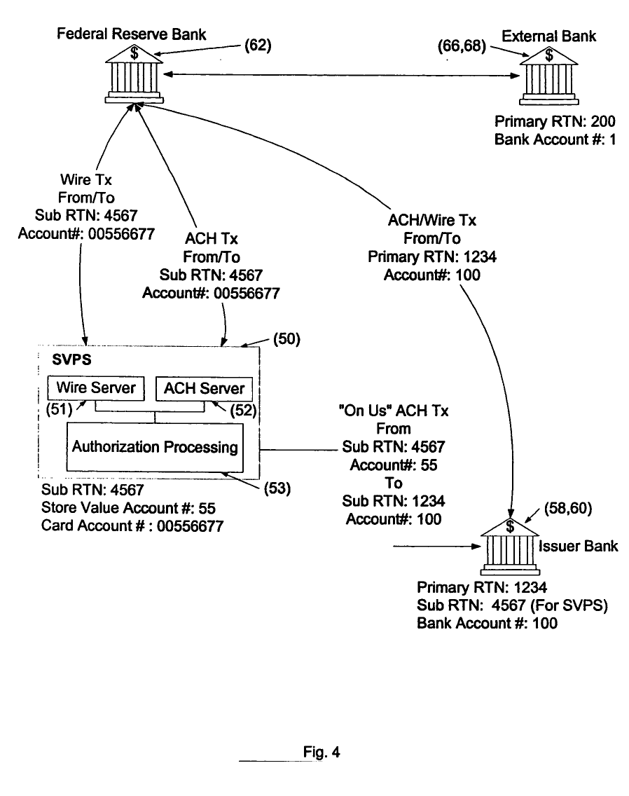

The settlement process is shown in more detail in FIGS. 3 and 4. As previously stated, the user 10 will select one of the input devices or terminal in order to make a transaction request. The user identification and the request is contained in a user file 11a which is transmitted to an EFT (electronic funds transfer) network 29. The merchant acquirer 38 provides identifying and transaction information in a merchant file 11b which is also transmitted, as appropriate to the EFT. The combined files 11a and 11b are then transmitted to the virtual switch 30 for processing by the stored value processing system (SVP) 50. The SVP system initiates an authorization process 53 and a settlement process 54 using the customer data base 56. The issuer bank(s) 58 and 60 then transmit the funds via electronic transfer via the Federal Reserve ACH system 62 via ACH server 55 (FIG. 4), wire transfer via wire server 51 (FIG. 4) or via the ATM/POS system 64 depending on the identity provided by the issuer bank. The funds are then credited to the merchant bank(s) 66, 68.

The sub routing number and consolidation account routine is shown in FIG. 4. The issuer bank 58, 60 obtains a sub routing number from the Federal Reserve Bank 62 and creates a stored value consolidation account. The SVP system processes all transactions which are routed to the sub routing number. Internally the SVP system maintains a stored value consolidation account for each issuer bank 58, 60. Both accounts, consolidation accounts at the issuer banks and the consolidation account maintained by the SVP system, will tally as SVP updates the internal consolidation account in real time upon a transaction processing, sending batch updates to the issuer bank. At the end of a processing day, the SVP system will send an “on us” type of ACH transaction to the issuer bank. As a practical matter the accounts will not always tally, but in a theoretical sense this is the way they function. Specifically, the SVP system maintains detailed account and transaction information, whereas the consolidation account represents the total balance of all SVP accounts with limited net daily charge transactions. No individual account transactions or balances are reflected in the SVP system.

The following scenarios more clearly define how this process works:
Scenario 1—Day One, SVP system consolidation account and issuer bank consolidation account balances are both $0.00.
a. The Federal Reserve Bank receives an incoming wire transaction routed to routing number 4567 and account number 00556677 (as indicated in FIG. 4) in the amount of $100.00, and adds $100.00 to the issuer bank's primary routing number 1234, and routes the transaction to routing number 4567.
b. An incoming wire transaction in the amount of $100.00 is processed by the SVP system and adds $100.00 to the corresponding cardholder account number 00556677, and hence the SVP system consolidation account balance also increases by $100.00, but the issuer bank's consolidation account is still $0.00.
c. At the end of the processing day, an “onus” transaction of $100.00 will be issued by the SVP system to routing number 1234 and account No. 100 (as indicated in FIG. 4). At this point the issuer bank consolidation account and the SVP consolidation account balances become equal, i.e., $100.00.
Scenario 2—In this account, assume the SVP consolidation account and issuer bank consolidation account are equal at $200.00.
a. Three transactions are processed:
   i. an incoming ACH credit transaction of $100.00;
   ii. an outgoing ATM/POS transaction of $50.00; and
   iii. an Incoming wire transaction of $100.00.
b. The SVP system will update the corresponding cardholder account and the SVP consolidation balance would be $350.00. At this point in time, the issuer bank consolidation account is still $200.00. At the end of the processing day, an “on us” ACH transaction in the amount of $150.00 will be issued by the SVP system to sub routing No. 1234 and account No. 100, equalizing the issuer bank and SVP consolidation accounts at $350.00.

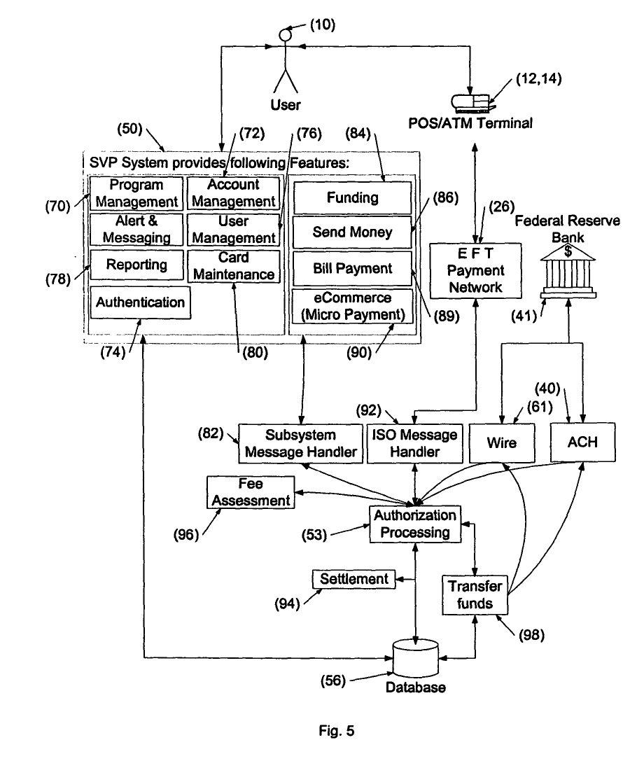

FIG. 5 is a diagram illustrating some of the available features of the SVP system. This shows the enhanced features of the system, particularly when compared to the ATM/POS network payment system. As indicated at the SVP system level 50, the system provides program management 70 and account management 72 in addition to authentication 74. When the user becomes registered with SVP, he supplies account management information which is used by the SVP through the user management feature 76. This is entered in the database 56 and utilized by the SVP system for authenticating the user and managing his accounts during each transaction. This program management provides a flexible payment system for the user while at the same time minimizing any merchant membership requirements. In addition, the SVP system provides alert and messaging capabilities 77, reporting 78 and card maintenance 80.

The SVP system 50 is also adapted for communicating with a subsystem message handler 82 for supporting finding 84, generating send money transactions 86, supporting bill payment 88 and for use as an eCommerce payment system 90. During the authorization processing sequence indicated at 53, the subsystem message handler 82 communicates with the SVP system 50 and an ISO message handler 92 communicates with the payment network 26. The settlement 94, fee assessment 96 and transfer of funds 98 are all managed by the authorization processing system 53 for communicating with the Federal Reserve and actuating transfers of funds via wire transfer 61 or via the ACH system 40.

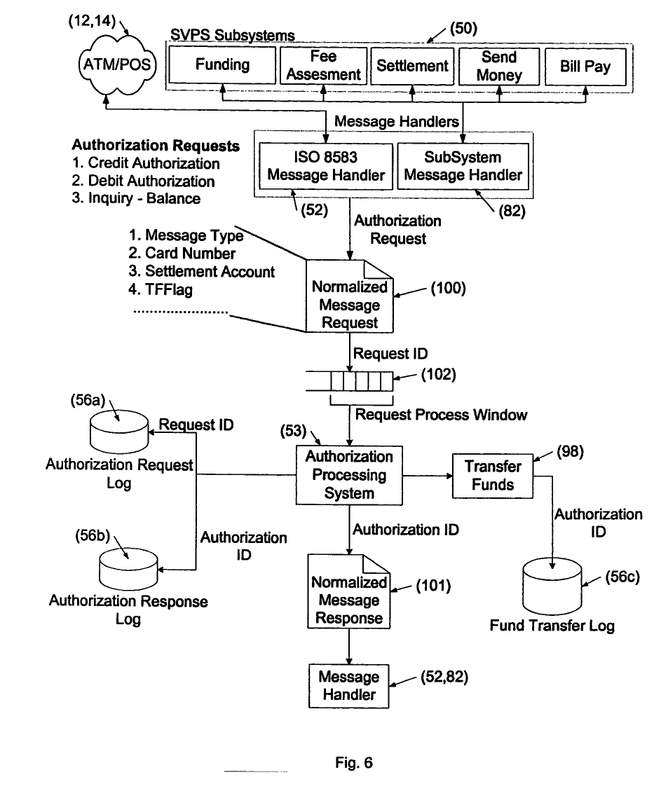

An overview of the authorization process is shown in FIG. 6. The user data entered at the ATM/POS terminal 12, 14 is transmitted to the message handler 52 for generating an authorization request 100. The request is issued with a request specific ID 102 and transmitted to the authorization processing system 53. This is transmitted to and logged in the database as a request ID 56a and an authorization ID 56b. The accept or rejection response is generated as a normalized message at 101 and transmitted back to the message handler system 52, 82. The authorization processing system transmits funds transfer information to the transfer funds system 98 and this is logged in the data base with the authorization ID at 56c. The authorization information is transferred to the SVP system 50 for managing funding, fee assessment, settlement and the transaction such as send money or bill pay, as previously described.

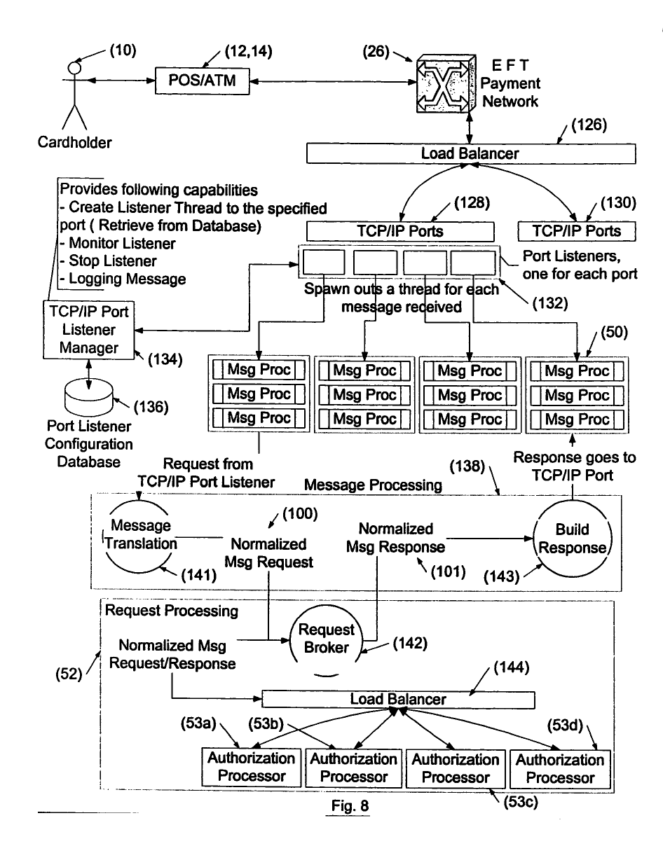

The authorization process detail is shown in the diagram of FIG. 8. Once an authorization request is queued up as indicated at 99, the normalized authorization request message 100 is generated and transmitted to a message parsing system 104 which is part of the authorization processing system 53. The message parsing routine checks the message type at 105, and based on the message type generates the appropriate pre-authorization message 106, financial transaction message 107, or when required a reversal or decline message 109. The system also monitors for duplicate transactions as indicated at 108 and updates the system files for the user as indicated at 110. Once the specific transaction is identified and approved, the authorization strategy 114 is requested by and sent to the authorization retrieval subsystem 112. This then initiates and manages the authorization tasks as indicated at 116, including user specific and controlled information such as the card identification 118, limit validations 117 and the specific account to be used 119. This in turn initiates the transaction via wire 120 or ACH 121. The system also validates and checks other information as indicated at 122, including but not limited to account validations, address verification, routing validations, financial institution (FI) validations, card validations, external fraud check, PIN validations, funds availability, velocity check, money transfer partner (MTP) validations, card verification code/card verification value (CVC/CVV) check and merchant limitations. An authorization response is then generated at 124 and transmitted as a normalized message 101 back to the terminals 12, 14 and the subsystem message handler 82.

A diagram of the message handler overview is shown in FIG. 8. As previously described, the user 10 will initiate a transaction at a POS/ATM terminal 12, 14. As also previously described, the input terminal or device is not limited to a POS/ATM terminal (see FIG. 1), but is so limited here for purposes of illustration only. The input data is then transmitted to the EFT payment network 26 and from there to a load balancer 126 for transmission via various TCP/IP ports 128, 130. There are port listeners 132 assigned to each port on a one-to-one bases for detecting incoming messages and spawning out a thread for each message received. The TCP/IP port listener manager 134 configures the ports and the spawned messages in accordance with the port listener data base 136. Each message is processed by the message processing system 138, wherein the message is translated into a normalized message request 100 and transmitted to the request handler or broker 142. The request broker then communicates with various authorization processors 53a-53d via the load balancer 144 for processing the transaction as described above and generating a normalized message response 101 which is completed at 143 and transmitted back into the network via the TCP/IP ports.

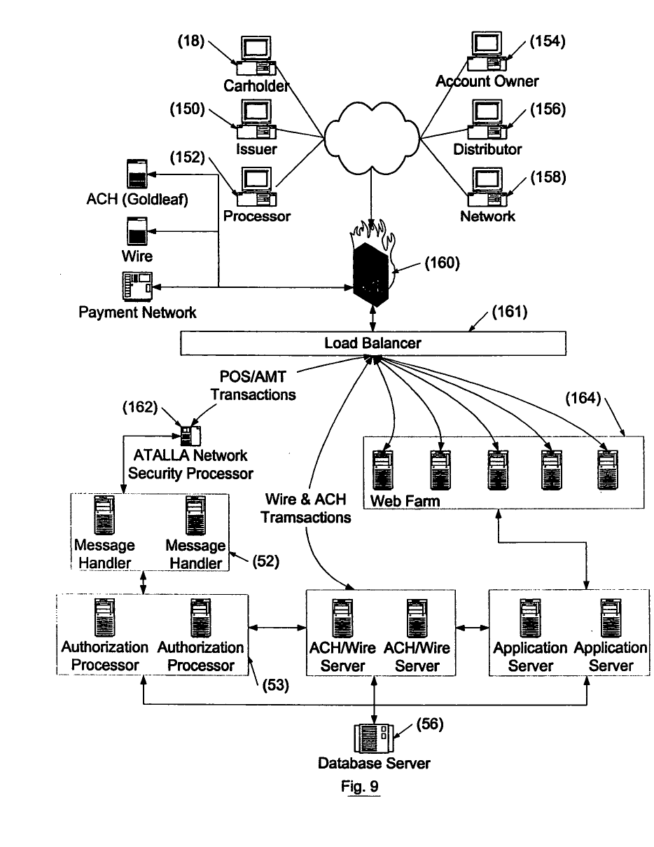

A typical network for Internet transmission and transactions is shown in FIG. 9. Various PC's or other input devices such as the cardholder/user PC 18, issuer PC 150, transaction processor PC 152, account owner PC 154, distributor PC 156 and network PC 158 are connected to the Internet 28 in typical fashion. A security firewall 160 is between the Internet 28 and the SVP system. The various transaction handling networks such as ACH40, Wire 61 and the payment network 26 also communicate with the SVP system via the firewall 160. Traffic is managed by the load balancer 161. In a typical system, POS/ATM transactions are managed through a security processor 162 which is adapted to communicate with the message handler system 52 and the authorization processor 53. This system may be duplicated numerous times as indicated by the web farm 164. The SVP system then handles information and transactions between the input devices, the system, ACH wire servers and application servers in connection with the database 56 in the previously described manner.

Under the user management functions, the system has the ability to create, view, modify, enable, disable and delete users. SVP users will possess valid user credentials enabling them to log onto the system. This can be user ID and password, card data, biometric identification or other authentication criteria. The processors are users of the system that act in behalf of the SVP processor to perform maintenance and administrative functions. The issuers act in behalf of the SVP issuer to perform customer service roles and other maintenance or administrative roles in connection with the issuer. Network users are typically employees of the SVP network. Distributors act on behalf of the SVP network for customized users such as payroll systems or the like. The cardholders are the individual users acting on their own behalf The account owners generally do not have cards but use the system to send wire transfers, pay bills, and transfer finds through any of the SVP services. The SVP system provides the ability to manage the right and features available to many users at the same time by assigning users to a role which grants access to specific features.

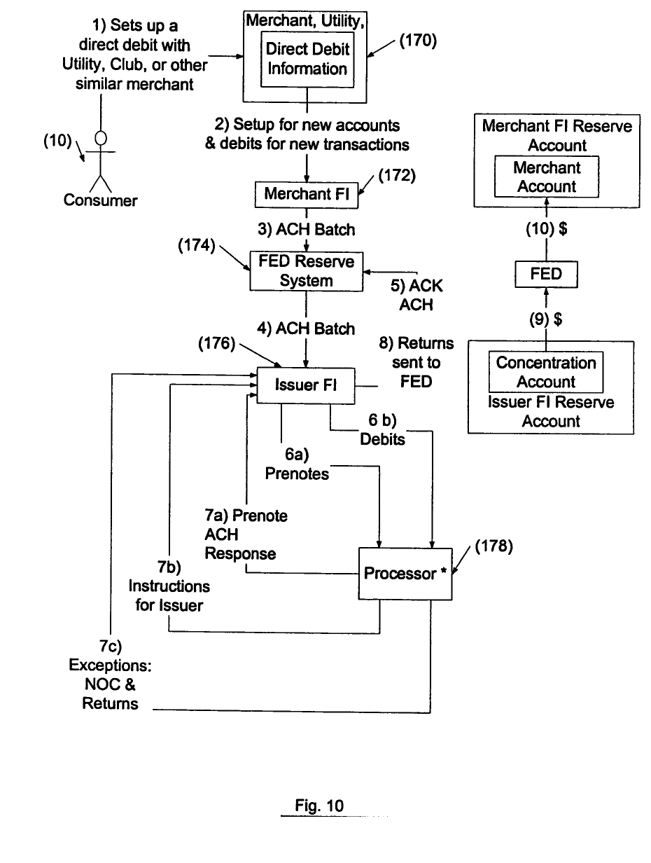

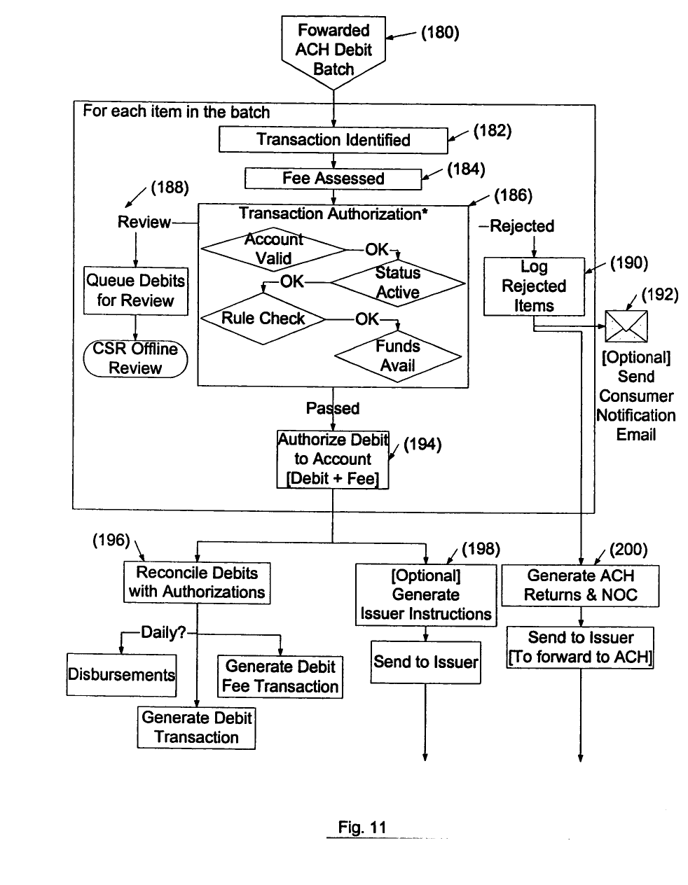

A typical direct debit settlement transaction is shown in FIGS. 10 and 11. This is set forth merely as an example. It will be understood that other transactions are similarly handled by the system. In the example, the user 10 sets up a direct debit with a utility, club or merchant as indicated at 170 for a recurring regular payment. For new direct debits, the merchant sends a prenote ($0.00 value) to verify routing and account information provided by the user. If the prenote is successful, the merchant can send recurring debit transactions from then on. These are forwarded to the merchant's financial institution (FI) as indicated at 172. The merchant FI forwards the ACH transactions to the Federal Reserve system as indicated at 174. The Federal Reserve system then issues or forwards the debits to the issuer FI as indicated at 176. The issuer FI returns the appropriate acknowledgement. The issuer FI filters out the specific transaction from the ACH batches for the subroutine associated with the SVP system and forwards the SVP transaction to the SVP processor, here indicated as 178. Prenotes and debits are separated by the SVP processor. The processor performs the necessary checks based on the card program, account rules and available balance as previously described and issues a response and instructions. Prenotification batches are created and sent to the issuer for forwarding to the Federal system. Instructions are sent to the issuer to move the money, as required. An exception ACH batch is also created and sent to the issuer for submission to the Federal system. The Federal system then transfers money from the issuer FI to the merchant FI to settle the transactions.

The settlement flow chart is shown in FIG. 11 and begins with a forwarded ACH debit batch 180. For each item in the batch, the transaction is identified at 182, the fee is assessed at 184 and transaction authorization is initiated as indicated at 186. At this point, the authorization process determines if the account is valid and on active status. The appropriate rules are checked and applied and the availability of funds is determined. A review file is generated at 188. Rejected transactions are logged as indicated at 190 and the user may be notified as indicated at 192. Accepted or “passed” transactions are transmitted to the debit authorization program 194 where the debits are reconciled with authorizations as indicated at 196 and where the user is optionally issued appropriate messages as indicated at 198. Rejected transactions are also sent back to the user as indicated at 200.

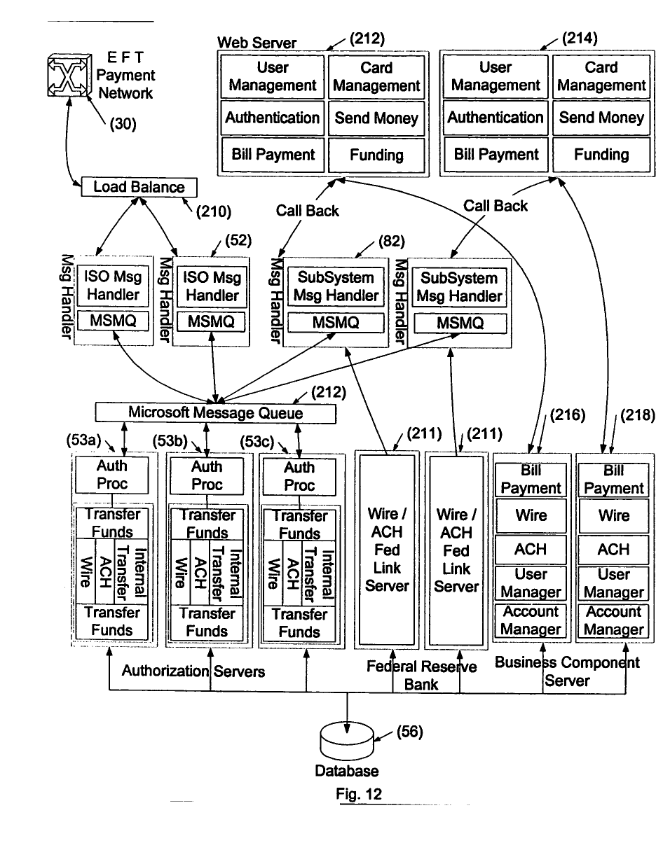

FIG. 12 is a comprehensive system diagram. The virtual payment switch 30 receives the transaction input data from any of various inputs as previously shown and described in connection with FIG. 1. The traffic is managed by the load balance network 210, from where the incoming data is transmitted to the various message handling systems 52, 82. The messages are the transmitted and received through a message handling queue such as, by way of example, a MicroSoft message queue 212, for transmitting and receiving transaction requests and transaction information to and from the various authorization processing systems 53a-53c. This is linked to the web servers 212, 214 for authentication, management, funding, payment and money sending transactions as previously described. Transactions are settled via the wire or ACH Federal reserve link 211 as previously described. The system database 56 is connected to all components as indicated. The system may also include one or more business component servers 216, 218 for bill payment, wire and ACH transfers and the like in accordance with user management input and account management input.

From the foregoing, it will be understood the subject invention provides a payment system that does not rely on credit or debit cards, does not require the merchant and purchaser to have compatible memberships to complete a transaction, and does not limit single transactions to a single account. The system has a wide range of flexibility and permits debit, credit, pre-paid and payroll cards to be accommodated in a seamless and invisible manner. The transaction may be verified and approved at the point-of-sale whether or not the merchant is a member of a specific financial transaction system. Specifically, the point-of-sale transaction system of the subject invention permits an identified customer to use any of a variety of payment options to complete the transaction without requiring the merchant to pre-approve the type of payment selected by the customer. In order to take advantage of the widespread use of the ATM/POS network, the invention uses a typical credit/debit card format to provide the identifying information in a stored value card using the stored value processing (SVP) system of the subject invention. When a transaction is to be completed, the user enters the identifying information carried on the SVP card at the point-of-sale. This can be a merchant or other service provider at a retail establishment, or on-line while the user is logged onto a web site, or other location. The information can be swiped by a card reader, or manually entered via a keyboard or other input device.

The system of the subject invention supports a wide range of flexibility, permitting issuing systems such as parents and state welfare agencies to restrict the types of authorized uses, and permitting users to access accounts in a prioritized manner. Further, the accepting merchant is not required to be a member because settlement with the merchant may be made via the ACH system by typical and standard electronic transfer. This permits the merchant to take advantage of the lower ACH transaction fees with even greater convenience and flexibility than the current ATM/POS system.

The system of the subject invention supports numerous types of identification methods from typical credit card structures with magnetic data strips to various biometric systems such as finger prints, facial recognition and the like. Specifically, once the SVP user is identified, the transaction is managed by his membership data on record with the transaction processing system.

While certain features and embodiments of the invention have been described in detail herein, it should be understood that the invention encompasses all modifications and enhancements within the scope and spirit of the following claims.

1. A payment system for making an electronic payment by a user to a provider via an electronic interface, the system comprising:
a. an input device for receiving user data and a requested transaction;
b. a transmitting network for transmitting the user data and the requested transaction;
c. a receiver processing system for receiving the user data and the transaction;
d. the receiver processing system further including an authentication system for authenticating the user and the transaction, approving the transaction and initiating completion of the transaction in accordance with criteria established by the user.

2. The payment system of claim 1, wherein the input device is a point-of-sale terminal.

3. The payment system of claim 1, wherein the input device is an ATM/POS terminal.

4. The payment system of claim 2, further including a payment transaction gateway and wherein the receiver processing system is adapted for communicating with the payment transaction gateway to receive authenticated user requests.

5. The payment system of claim 3, further including a payment transaction gateway and wherein the receiver processing system is adapted for communicating with the payment transaction gateway to receive authenticated user requests.

6. The payment system of claim 1, wherein the input device is connected to the receiver processing system via the Internet.

7. The payment system of claim 1, further including at least one financial institution adapted for communicating with the receiver processing system and wherein the requested transaction is completed through the financial institution in accordance with criteria set by the user and managed by the receiver processing system.

8. The payment system of claim 1, wherein the receiver processing system is adapted for communicating with the Federal Reserve Automatic Clearing House (ACH) system and the authenticated transaction is completed by transferring funds via the ACH system.

9. A method for making an electronic payment comprising the steps of:
a. establishing authenticating criteria for a user;
b. entering user data via an input device;
c. entering a requested transaction at the input device;
d. transmitting the user data and the transaction to a processing system;
e. authenticating the user;
f completing the transaction in accordance with pre-established criteria controlled by the user.

10. The method of claim 9, wherein the pre-established criteria includes establishing a hierarchy for selecting completion of the transaction from a plurality of user controlled accounts.

11. The method of claim 9, wherein the transaction is completed via the Federal Reserve Automatic Clearing House (ACH) regardless of the input device.
